(19) United States
(12) Patent Application Publication
(10) Pub. No.: US 2014/0318245 A1
(43) Pub. Date: Oct. 30, 2014

(54) IMPACT DETECTION DEVICE

(71) Applicant: DAINESE S.P.A., MOLVENA (IT)

(72) Inventors: Mattia Perego, Gallarate (IT); Cristian Previtali, Bonate Sopra (IT); Enrico Silani, Gavirate (IT)

(21) Appl. No.: 14/359,897

(22) PCT Filed: Nov. 23, 2012
(86) PCT No.: PCT/IB2012/056668

§ 371 Date: May 21, 2014

(30) Foreign Application Priority Data
Nov. 24, 2011 (IT) VR2011A000210

(51) Int. Cl. G01P 15/18; G01P 1/00

(52) U.S. Cl. CPC G01P 15/18; G01P 1/00
USPC 73/510; 29/836

(57) ABSTRACT

A method for positioning an impact detection device on a rod-shaped member of a fork of a vehicle supporting a wheel of the vehicle is described. The detection device has at least one group of three accelerometers arranged on three axes orthogonal to each other and mounted on at least one printed circuit board, the at least one printed circuit board being arranged in a plane parallel to a longitudinal axis of the right-shaped member of the fork.

The present disclosure relates in general to the detection of impacts in a vehicle, for example a wheeled vehicle, with particular but not exclusive reference to the sector of motorcycles. More particularly, the disclosure relates to the positioning of an impact detection device on a motorcycle, suitable for allowing activation of an automatic impact protection system.

In the sector of motorcycles and in particular motorcyclists' clothing, automatic impact protection systems, generally associated with jackets and one-piece suits, are increasingly common. The automatic protection systems generally comprise a plurality of air-bags which can be automatically activated in the event of an accident so as to protect the motorcyclist from the impact when falling and/or during a collision with other vehicles.

At present, automatic protection systems of the wireless type are increasingly common, activation of the air-bag being managed in these systems by a remote control unit connected to an impact detection device comprising one or more accelerometers. The accelerometers of the detection device are able to detect the accelerations to which the motorcycle is subject during travel and in particular the negative accelerations which affect the vehicle in the event of an impact. The electric signals generated by the accelerometers are sent to the control unit which, when a predetermined deceleration threshold is exceeded, activates the airbags.

The impact detection device is generally mounted on the motorcycle and in particular in the vicinity of the axle of the front wheel. This arrangement is considered to be the most suitable for detecting the accelerations acting on the motorcycle and in particular the negative accelerations in the event of an accident.

The aforementioned automatic systems are associated with motorcyclists' garments which are sold separately from the motorcycle and comprise both “internal” elements incorporated in the garments, for example the air-bags and a receiving control unit, and “external” elements to be mounted on the motorcycle, for example the impact detection device and a transmitting control unit.

One of the main problems of automatic protection systems is that of their capacity to distinguish in real time the behaviour of the motorcycle during normal travel, including racing conditions, from the behaviour arising following an impact.

Another problem is that of fitting and adapting the “external” elements of an automatic protection system to motorcycle models which are different from each other and in particular that of positioning the impact detection device on the fork. If, in fact, the transmitting control unit may be hidden underneath the saddle or housed in the instrument panel of a motorcycle, the impact detection device is clearly visible on the fork of the motorcycle, forming a bulky object which may alter the appearance of the motorcycle.

There therefore exists the need to provide a method for positioning an impact detection device on a fork which alters as little as possible the appearance of the motorcycle, this forming one object of the present disclosure.

Another object of the present disclosure is to provide a positioning method which allows the accelerations acting on the motorcycle to be continuously detected and the impact situations to be determined as rapidly as possible.

Said objects are achieved with a positioning method, the main characteristic features of which are respectively specified in claim 1, while other characteristic features are specified in the remaining claims. Said objects are also achieved by an assembly consisting of the impact detection device and a fork according to claim 8.

A proposed solution forming the basis of the present disclosure consists in the use of a triaxial impact detection device, namely a device comprising accelerometers arranged along three axes orthogonal to each other. In this way it is possible, by means of suitable mathematical operations, to relate the acceleration values detected by each accelerometer to a group of three orthogonal reference axes of the motorcycle, in particular the three main axes relative to which the rolling, pitching and yawing movements are defined.

Another proposed solution forming the basis of the present disclosure is that of positioning the impact detection device on the rod-shaped members or arms of the fork so that the printed circuit boards on which the accelerometers are mounted extend parallel to the respective rod-shaped members.

The inventor has in fact noted that the printed circuit boards which allow detection of the accelerations in fact normally require printed circuit boards which have fairly large dimensions in plan view compared to those of the individual accelerometers. Moreover, in order to detect accelerations along three axes which are perpendicular to each other, it is necessary to arrange the accelerometers and the associated printed circuits perpendicularly with respect to each other, this increasing the overall dimensions of the detection device.

By arranging the printed circuit boards parallel to the rod-shaped members of the fork it is possible to minimize the dimensions of the impact detection device in particular in the transverse direction of the motorcycle, reducing the visual impact thereof and possible negative effect on the appearance.

According to one embodiment of the present disclosure, the detection device comprises a pair of printed circuit boards which are arranged at right angles and on which the accelerometers for the X and Y axes and for the Z axis are respectively mounted. The printed circuit boards on which the accelerometers are mounted are arranged inclined at 45 degrees with respect to a median plane of the wheel, thus forming an arrangement characterized by dimensions which are very small in the transverse direction.

According to a further embodiment of the present disclosure, the detection device comprises a single printed circuit board on which two conventional accelerometers for the X and Y axes, respectively, and a third accelerometer able to detect accelerations on a axis Z perpendicular to the axes X and Y are mounted.

According to a further embodiment of the present disclosure, the impact detection device comprises two groups of three accelerometers respectively intended to be mounted on two rod-shaped members of the fork, namely on the right-hand rod-shaped member and on the left-hand rod-shaped member, thus making it possible to obtain a detection system which is redundant and able to cancel out the accelerations which arise as a result of rotation of the steering about its axis.

The two groups of three accelerometers are placed in a mirror arrangement with respect to the longitudinal median plane of the wheel of the motorcycle and asymmetrically with respect to its axis of rotation. In this way it is possible to reduce the number of mathematical operations required to relate the acceleration values measured by the different accelerometers to the three main axes of the motorcycle, thus reducing to a minimum the time required by the calculation algorithm to determine impact situations.

Further advantages, characteristic features and modes of use of the subject of the present disclosure will become clear from the following detailed description of a number of preferred embodiments thereof, provided by way of a non-limiting example. It is clear, however, that each embodiment may have one or more of the advantages listed above; in any case it is not required that each embodiment should have simultaneously all the advantages listed.

It is also to be understood that the scope of the present disclosure embraces all the possible combinations of the embodiments mentioned above and those described with reference to the following detailed description.

Reference shall be made to the figures in the accompanying drawings in which:

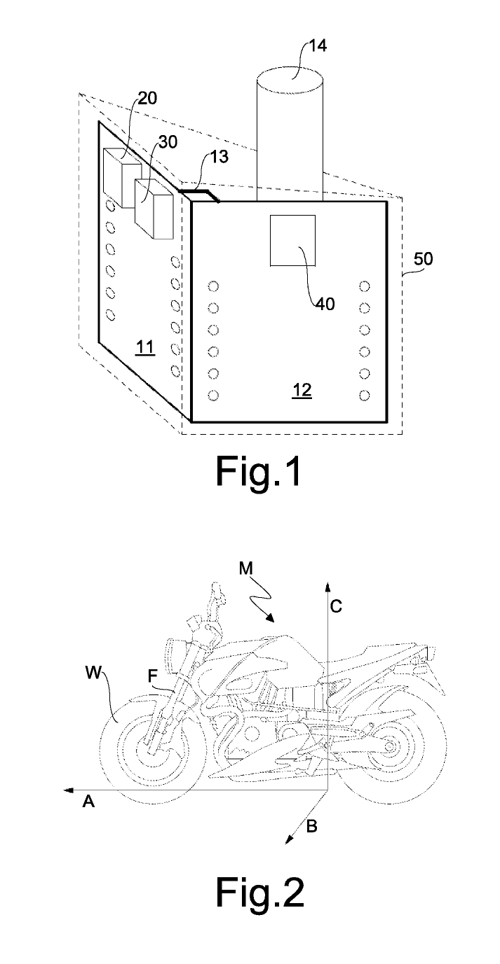

FIG. 1 is a perspective view which shows in schematic form an impact detection device comprising a group of three accelerometers arranged along three orthogonal axes;

FIG. 2 shows in schematic form a motorcycle on the fork of which the impact detection device according to FIG. 1 is mounted;

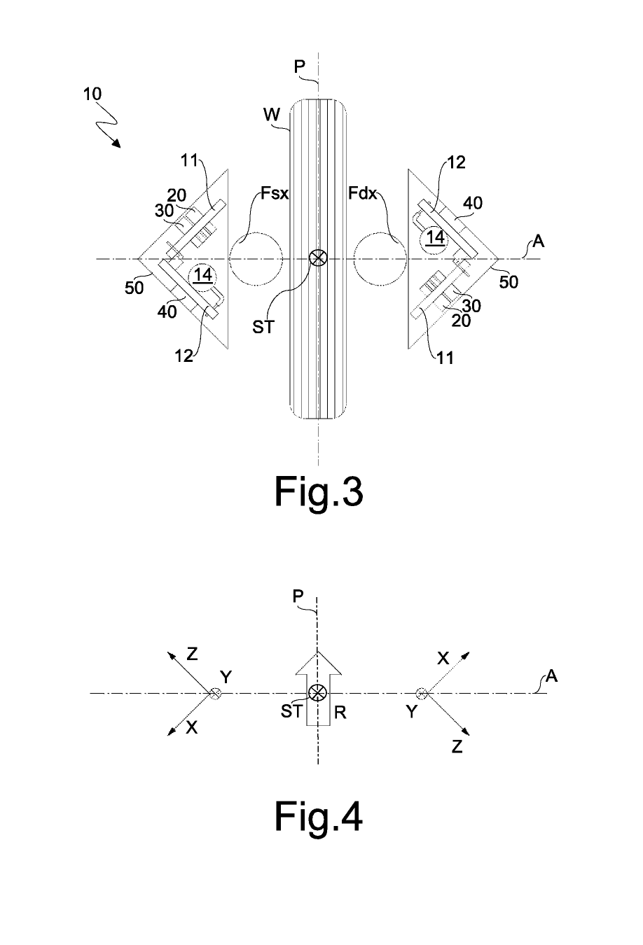

FIG. 3 is a top-plan view which shows in schematic form positioning of the impact detection device with respect to the fork of the motorcycle; and

FIG. 4 is a diagram which shows the arrangement of the reference axes of the accelerometers of the impact detection device with respect to the fork of the motorcycle.

With reference to the figures, a triaxial impact detection device 10 comprises in particular a group of three accelerometers 20, 30, 40 respectively arranged along three axes X Y and Z perpendicular to each other and suitable for detecting accelerations respectively directed along these axes.

From a constructional point of view, in the embodiment shown in the figures, a first accelerator and a second accelerator are coplanar and may be mounted on a first printed circuit board, and a third accelerometer mounted on a second printed circuit board arranged perpendicularly with respect to the first printed circuit board.

In the embodiment shown, the accelerometers 20, 30 arranged along the axes X and Y are coplanar and are both mounted on a first printed circuit board 11, while the accelerometer 40 arranged along the axis Z is mounted on a second printed circuit board 12 connected to the first printed circuit board 11 by means of a right-angled connector 13. The detection device 10 also comprises a cable 14 for connection to a transmitting unit (not shown) suitable for transmitting the electric signals emitted by the accelerometers 20, 30, 40 to a receiving unit (not shown) of an automatic protection system (not shown) comprising a plurality of air-bags, for example associated with a motorcyclist's jacket or suit. The group of three accelerometers 20, 30, 40 with the respective printed circuit boards 11, 12 are housed inside a container 50 shown schematically in broken lines in FIG. 1.

It may be understood, however, that the accelerometers mounted on the printed circuit boards may be all of the same type and that the association of the electric signals generated by them with accelerations along the three axes X, Y, Z is merely conventional. For example, the two accelerometers 20, 30 mounted on the first printed circuit board 11 could be associated with axes, X, Z and the accelerometer 40 mounted on the second printed circuit board could be associated with the axis Y.

In the embodiment shown, the container 50 has a prismatic shape which is substantially triangular in plan view and reproduces the arrangement of the printed circuit boards 11, 12.

As shown in FIG. 2, the detection device 10 is mounted on the fork F of a motor vehicle M in the vicinity of the axis of the wheel W, namely on the fork F which supports the wheel W.

According to the present disclosure, the detection device 10 is arranged so that the printed circuit boards 11, 12 are parallel to the axis of the fork F, namely are arranged in planes parallel to planes passing through the rod-shaped members Fsx, Fdx of the fork F. In this way it is possible to minimize the dimensions of the detection device 10 in the transverse direction, since the printed circuit boards, and likewise the components mounted thereon, do not occupy much space in the direction of the thickness, while they have generally much larger dimensions as regards the planes in which the components are mounted and in which the conduction paths are formed.

In the embodiment shown in FIG. 3, the printed circuit boards 11, 12 are preferably arranged inclined at 45 degrees with respect to a longitudinal median plane P of the wheel W (namely in the median plane P of the fork F) and symmetrically with respect to its axis A of rotation, which passes through the end zones of the rod-shaped members Fsx, Fdx of the fork F.

This configuration is able to minimize the dimensions of the detection device 10 transversely with respect to the motorcycle M since, considering the embodiment shown in FIG. 1 which comprises a prismatic container 50 with a triangular base, the base of the triangle is parallel to the longitudinal median plane P of the wheel W and the inclined sides are directed towards the outside of the motorcycle M.

As shown in FIG. 3, the detection device 10 preferably comprises two groups of three accelerometers 20, 30, 40 which are identical and respectively intended to be mounted on each of the rod-shaped members of the fork F of the motor vehicle M, for example the left-hand and right-hand stems Fsx, Fdx in a mirror arrangement with respect to a longitudinal median plane of the wheel W. As a result it is possible to obtain redundancy characteristics during detection of the accelerations.

As a result of mounting of the two groups of three accelerometers in a mirror arrangement it is possible to cancel out the accelerations which arise as a result of rotation of the wheel during steering of the motorcycle M, which would inevitably affect the general calculation of the accelerations.

With reference now to FIG. 4, it can be noted that, owing to the mirror arrangement of the two groups of three accelerometers and the 45 degrees inclination of the printed circuit boards 11, 12, with respect to the longitudinal median plane P of the wheel W, the axes Y of each group of three accelerometers are oriented in the same direction and are parallel to the axes of the stems Fsx, Fdx of the fork F. The axes X and Z are perpendicular to each other and inclined by 45 degrees with respect to the longitudinal median plane P of the wheel W. The axes Y of each group of three accelerometers are in particular directed towards the ground.

With respect to the direction of forward movement of the motorcycle M, indicated in the figure by means of an arrow R, in the left-hand stem Fsx the access Z is inclined by 135 degrees with respect to the axis A of rotation of the wheel W, while the axis X is inclined by −130 degrees with respect to the axis A of rotation of the wheel W. In the right-hand stem Fdx, instead, the axis Z is inclined by −45 degrees with respect to the axis A rotation of the wheel W, while the axis X is inclined by 45 degrees with respect to the axis A of rotation of the wheel W. The groups of three accelerometers are therefore arranged asymmetrically with respect to the axis A of rotation of the wheel W of the motorcycle M.

Comparing FIG. 4 with FIG. 2, it can be understood that the arrangement of the accelerometers 20, 30, 40, and therefore of the axes X, Y, Z, arising from the configuration and the positioning of the detection device 10 described above, does not correspond to the three main axes or reference axes of the motorcycle M, which are indicated respectively by the letters A, B and C and which respectively represent the rolling, pitching and yawing axes.

In order to be able to perform calculations using the accelerations detected by the accelerometers 20, 30, 40, from a mathematical point of view conversion matrices must therefore be applied, “virtually” rotating the group of three accelerometers about their axes in successive steps so as to align them with the three main axes.

Still with reference to the embodiment shown in FIGS. 3 and 4, in both the groups of three accelerometers the sense of the axis Z is initially inverted.

For the group of three accelerometers associated with the left-hand stem Fsx of the fork F it is required to perform a first rotation through 45 degrees around the axis Y, a second rotation by −90 degrees around the axis Z which arises from the first rotation and finally a third rotation by 90 degrees around the axis Y which arises from the second rotation. The angle of the third rotation must furthermore be increased by the angle of inclination of the fork with respect to the ground, typically by about 26 degrees.

Similarly, for the group of three accelerometers associated with the right-hand stem Fdx of the fork F it is required to perform a first rotation by −135 degrees around the axis Y, a second rotation by −90 degrees around the axis Z which arises from the first rotation and finally a third rotation by 90 degrees around the axis Y which arises from the second rotation. In this case also, the angle of the third rotation must furthermore be increased by the angle of inclination of the fork with respect to the ground, typically by about 26 degrees.

As a result of the asymmetrical mirror arrangement (i.e. inverted by 180 degrees) of the two groups of three accelerometers, it is possible to minimize the virtual rotation operations needed to make them coincide with the three main axes of the motorcycle M, with the advantage of a greater rapidity of the control system during analysis of the data sent by the accelerometers in order to determine the impact situations and activate the air-bags of the protection system.

The embodiments of the present disclosure which are described and illustrated here constitute only examples which may be subject to numerous variations. For example, it is possible to form the detection device using a single printed circuit board for mounting two conventional accelerometers, for example those used in the embodiment described above, for the axes X, Y, and a third accelerometer which is coplanar with them, but able to detect accelerations on an axis Z perpendicular to the axes X, Y. In this way, the dimensions of the detection device 10 are further limited transversely with respect to the motorcycle M without complicating the calculation as regards the virtual rotations required to relate the two groups of three accelerometers to the three main axes of the motorcycle M. Moreover, it is possible to use the detection device according to the present disclosure also in combination with “external” elements such as air-bags and receiving control units arranged on the motorcycle or, more generally, on a wheeled vehicle, and not exclusively in the garments worn by the motorcyclist.

1. A method for positioning an impact detection device on a rod-shaped member of a fork of a vehicle, comprising
supporting a wheel of the vehicle with said fork supports,
arranging at least one group of three accelerometers of the detection device on three axes orthogonal to each other,
mounting at least two accelerometers on at least one printed circuit board, and
arranging said at least one printed circuit board in a plane parallel to a longitudinal axis of the rod-shaped member of the fork.

2. The method according to claim 1, wherein all the accelerometers of the group of three accelerometers are mounted on a common printed circuit board.

3. The method according to claim 1, wherein a first accelerometer and a second accelerometer of said group of three accelerometers are coplanar and mounted on a first printed circuit board and a third accelerometer is mounted on a second printed circuit board perpendicularly with respect to said first printed circuit board, and
wherein said first and second printed circuit boards are arranged in planes parallel to a longitudinal axis of the rod-shaped member of the fork.

4. The method according to claim 3, wherein the first and second printed circuit boards are further inclined by an angle of 45 degrees relative to a longitudinal median plane of the wheel of the vehicle.

5. The method according to claim 4, wherein the first and second printed circuit boards are further arranged symmetrically with respect to a rotation axis of the wheel.

6. The method according to claim 1, wherein the detection device comprises two groups of three accelerometers and wherein a first group of three accelerometers is arranged on a right-hand rod-shaped member of the fork of the vehicle and a second group of three accelerometers is arranged on a left-hand rod-shaped member of the fork.

7. The method according to claim 6, wherein the two groups of accelerometers are arranged rotated relative to each other by an angle of 180 degrees around a steering axis of the fork with rotation being centred on the steering axis.

8. An assembly comprising:
an impact detection device; and
a fork suitable for supporting a wheel of a vehicle, wherein:
said fork comprising two rod-shaped members and said detection device comprising at least one group of three accelerometers arranged on three axes orthogonal to each other,
at least two of said accelerometers are mounted on at least one printed circuit board, and
said at least one printed circuit board is arranged in a plane parallel to a longitudinal axis of the rod-shaped member of the fork.

9. The assembly according to claim 8, wherein all the accelerometers of the group of three accelerometers are mounted on a common printed circuit board.

10. The assembly according to claim 8, wherein a first accelerometer and a second accelerometer are coplanar and mounted on a first printed circuit board and a third accelerometer is mounted on a second printed circuit board perpendicularly with respect to said first circuit board, and
wherein said first and second printed circuit boards are arranged in planes parallel to a longitudinal axis of at least one rod-shaped member of the fork.

11. The assembly according to claim 10, wherein the first and second printed circuits are further inclined by an angle of 45 degrees relative to a longitudinal median plane passing between the two rod-shaped members of said fork.

12. The assembly according to claim 10, wherein the first and second printed circuit boards are further arranged symmetrically with respect to an axis of rotation of the wheel passing through end zones of the two rod-shaped members of the fork.

13. The assembly according to claim 9, wherein the detection device comprises two groups of three accelerometers, and
wherein one group of three accelerometers is arranged on one of the two rod-shaped members of the fork and one group of three accelerometers is arranged on the other of the two rod-shaped members of the fork.

14. The assembly according to claim 13, wherein the two groups of three accelerometers are arranged rotated relative to each other by an angle of 180 degrees around a steering axis of the fork with rotation being centred on the steering axis.

15. The assembly according to claim 14, wherein the two groups of three accelerometers are placed in a mirror arrangement relative to a longitudinal median plane passing between the two rod-shaped members of said fork and asymmetrically with respect to an axis of rotation of the wheel passing through end zones of the two rod-shaped members of the fork.

16. The assembly according to claim 8, further comprising:
a receiving control unit, suitable for receiving electrical signals from said detection device, and
at least one air-bag operatively connected to said control unit,
wherein said receiving unit and said at least one air-bag are associated with a garment and/or with a wheeled vehicle.

17. A wheeled vehicle (M) comprising an impact detection device, wherein said detection device is arranged according to the method of positioning of claim 1.

18. A wheeled vehicle comprising an impact detection device, wherein said detection device comprises the assembly according to claim 8.
